(19) United States
(12) Patent Application Publication
(10) Pub. No.: US 2003/0218541 A1
(43) Pub. Date: Nov. 27, 2003

(54) Security devices and security system

(76) Inventor: Yasuhiro Sakai, Tokyo (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/382,464

(22) Filed: Mar. 6, 2003

(30) Foreign Application Priority Data
Mar. 7, 2002 (JP) 2002-62728
Jul. 5, 2002 (JP) 2002-197738

(51) Int. Cl. G08B 13/08

(52) U.S. Cl. 340/545.1

(57) ABSTRACT

A security device and a security system are provided which require no power supply wires and thus can be installed at any location where a burglary prevention measure is necessary. The security device comprises: a generator member having a piezoelectric element and an impact member, the impact member striking against the piezoelectric element to generate electricity; an alarm unit to issue an alarm by using the generated power; and a control member to control an operation of the alarm unit; wherein one of the generator member and the control member is mounted on a door or window and the other is mounted on a nearby portion that parts from the door or window as the door is opened; wherein when the door or window is opened, the control member causes the alarm unit to operate.

### BACKGROUND OF THE INVENTION

1. Field of the Invention

The present invention relates to a technical field of a security device and a security system for preventing a possible burglary into a house or building.

2. Description of the Prior Art

A variety of kinds of antiburglary equipment or security device have been known for use in houses and offices. Many of these equipment are generally installed at front doors and windows or on fences and outer walls around the house to detect when a burglar opens a door or window or climbs a fence or outer wall and raise an alarm.

Such a security device needs to have an electric supply so that it remains ready at all times to be activated whenever a burglar breaks in. For the supply of electricity, the equipment is wired from a power line. However, when the security device is installed around the house, as on windows, fences or outer walls, a circuit wire is often exposed to view. This gives rise to a fear that the burglar may easily notice the wire and avoid the security device, or cut off the wire. As a result the security device may not function as intended. When a battery is used as a power source, other problems arise, such as a possibility that the battery may be dead during service and a frequent replacement of the battery.

When the security device is used in a home, for example, in a single-family house, a burglar may break in through a front door, back door, window, outer wall or fence. If the security device are installed on all of them and put into operation at all times, the cost of electricity will be enormous and there has been a call for reducing the running cost.

Further, when the security device is installed on the inner side of glazed windows or around the house, as on fences and outer walls, it may easily be noticed by the burglar if the equipment is large in size. For this reason, there has been a demand that the equipment be reduced in size or concealed.

In light of the problems described above, it is an object of the present invention to provide a self-generating type security device and security system which can obtain electricity without requiring electric wires or battery replacement and which can easily be reduced in size.

### SUMMARY OF THE INVENTION

To realize the above objective, the security device of this invention employs the following means.

According to a first aspect, the present invention provides a security device which comprises: a generator member having a piezoelectric element and an impact member, the impact member striking against the piezoelectric element to generate electricity; wherein a status change is detected at a location that requires an antiburglary protection, and a power produced by the generator member is used to raise an alarm.

With this means, in the event that some status change occurs at a location where a protection against theft, mischief or burglary is needed, the security device of this invention detects this status change and issues an alarm by using a power that is self-generated by the impact member striking against the piezoelectric element. The alarm refers to an annunciation of the incident either to surroundings or to a remote location or to both by means of sound, light and voice as well as transmission of a signal. The relation between the self-generation of power by the generator member and the alarm may be implemented in a configuration where the detection of a status change initiates the generation of electricity by the generator member and thereby issues an alarm; in a configuration where the generator member is already generating electricity but its output is restricted and where the detection of a status change initiates the output of the generated power and thereby triggers an alarm; and in a configuration where a power already generated by the generator member is supplied to an alarm means but an output of an alarm is disabled and where the detection of a status change initiates the output of an alarm.

According to a second aspect, the present invention provides a security device which comprises: a generator member having a piezoelectric element and an impact member, the impact member striking against the piezoelectric element to generate electricity; an alarm unit to issue an alarm by using the generated power; and a control member to control an operation of the alarm unit; wherein one of the generator member and the control member is mounted on a door or window and the other is mounted on a nearby portion that parts from the door or window as the door is opened; wherein when the door or window is opened, the control member causes the alarm unit to operate.

With this means, when the door or window is opened, the control member causes the impact member to impinge on the piezoelectric element. With the self-generation operation initiated, the alarm unit receives the generated power and issues an alarm, annunciating that the door or window was opened. The door or window includes a hinged door, sliding door, glazed window, rain protection sliding shutter, and door of safe or container. The nearby portion includes a surrounding frame of the door, fixtures, wall and another door. The another door functioning as a nearby portion may be opened at the same time that the door of interest is opened, or may remain closed.

According to a third aspect, the present invention provides a security device which comprises: a generator member having a piezoelectric element and an impact member, the impact member striking against the piezoelectric element to generate electricity; an alarm unit to issue an alarm by using the generated power; and a control member to control an operation of the alarm unit; wherein one of the generator member and the control member is mounted on a displacement portion that is displaced when a door or window is opened and the other is mounted on a nearby portion that parts from the displacement portion when the door or window is opened; wherein when the door or window is opened, the control member causes the alarm unit to operate.

With this means, when the displacement portion is displaced as the door or window is opened, the control member causes the impact member of the generator member to impinge on the piezoelectric element. With the self-generation operation initiated, the alarm unit receives the generated power and issues an alarm, annunciating that the door or window was opened. The displacement portion which is displaced when the door is opened includes a door handle, lock and door closer. The nearby portion includes a door panel, surrounding portion of the lock, and door frame.

According to a fourth aspect, the present invention provides a security device which comprises: a generator member having a piezoelectric element and an impact member, the impact member striking against the piezoelectric element to generate electricity; an alarm unit to issue an alarm by using the generated power; and a control member to control an operation of the alarm unit; wherein one of the generator member and the control member is mounted on an object that has a possibility of being moved and the other is mounted on a nearby portion that parts from the object when the object is moved; wherein when the object is moved, the control member causes the alarm unit to operate.

With this means, when the object is moved as a result of theft or burglary, the control member causes the impact member of the generator member to impinge on the piezoelectric element. With the self-generation operation initiated, the alarm unit receives the generated power and issues an alarm, annunciating that the object of interest was moved. The object of interest may include a safe, CD (cash dispenser), ATM (automatic teller machine), jewel box, painting and fixtures. The nearby portion may include a floor, wall and surrounding furniture.

According to a fifth aspect, the present invention provides a security device which comprises: a generator member having a piezoelectric element and an impact member, the impact member striking against the piezoelectric element to generate electricity; an alarm unit to issue an alarm by using the generated power; and a line member provided near a fence or wall and directly or indirectly connected to the generator member; wherein the generator member is displaced by a change in a tension of the line member to generate electricity.

With this means, when a tension of the line member changes, as by pulling, the generator member to which the line member is directly or indirectly connected is also pulled, causing the impact member to impinge on the piezoelectric element. With the self-generation operation initiated, the alarm unit receives the generated power and issues an alarm. Since the line member is installed close to a fence or wall, a burglar approaching or climbing the wall or fence touches the line member. This changes a tension of the line member, resulting in an alarm that a burglar is on the fence or wall. In addition to a fence and wall, the line member may also be installed on a hedge.

According to a sixth aspect, the present invention provides a security device described in any one of the first to fifth aspect, wherein the generator member has a housing accommodating the piezoelectric element and the impact member and an elastic member having an elasticity and attached to the housing to oscillate the housing so that the impact member repetitively strikes against the piezoelectric element.

With this means, when the housing or elastic member is applied an external force, it enters into an oscillating state because of the elasticity of the elastic member, whereby the impact member repetitively impinges on the piezoelectric element to continually generate electricity. As a result, a large power can be produced by the generator member.

According to a seventh aspect, the present invention provides a security device described in the sixth aspect, wherein the elastic member is formed from an elastic body having a directivity in a spring constant and is connected to the housing such that a direction of the smallest spring constant of the elastic member agrees with a direction in which the impact member impacts the piezoelectric element.

With this means, the elastic member is most easily displaced in a direction in which the impact member impinges on the piezoelectric element. In other directions, the elastic member is not displaced as easily. This minimizes movements that would hinder the impinging action of the impact member against the piezoelectric element and also facilitates the transformation of motion of the impact member into the impinging action against the piezoelectric element.

According to an eighth aspect, the present invention provides a security device described in the sixth aspect, wherein the elastic member is formed from an elastic body having an expansibility, the elastic member is provided at both ends of the housing, and a contraction and expansion of the elastic members causes the impact member to oscillate and repeat impacting the piezoelectric element.

With this means, once applied an external force or vibration, the housing held between the elastic members enters into an oscillating state because of the elasticity of the elastic members, causing the impact member to repetitively impinge on the piezoelectric element and thereby generate electricity continuously. Since the housing is held between the elastic members, its vibratory direction is restricted.

According to a ninth aspect, the present invention provides a security device described in the eighth aspect, wherein the elastic member is attached to both opposite ends of the housing such that a direction of the contraction and expansion of the elastic member agrees with a direction in which the impact member impacts the piezoelectric element.

With this means, since the housing held between the elastic members oscillates with the expansion and contraction of the elastic members, the impact member is prompted to move in the impinging direction.

According to a tenth aspect, the present invention provides a security device described in any one of the second to ninth aspect, wherein a magnetic force is generated between the generator member and the control member, and when a change occurs in the magnetic force as a result of a parting between the control member and the generator member, the control member causes the generator member to start oscillating to operate the alarm unit.

With this means, the generator member and the control member are provided with a magnetic material and a magnetic layer or magnet to generate a magnetic force. As the generator member and the control member part from each other, the magnetic attractive force between them changes to pull the generator member or the magnetic repulsive force changes to push the generator member. This initiates the oscillating action of the entire generator member to self-generate electricity.

According to an eleventh aspect, the present invention provides a security device described in any one of the second to ninth aspect, wherein the generator member and the control member engage each other, and when they disengage from each other as a result of a parting between the control member and the generator member, the control member causes the generator member to start oscillating to operate the alarm unit.

With this means, the generator member and the control member engage each other in such a way as to block the oscillating action of the entire generator member. When they disengage from each other as the generator member and the control member move away from each other, the generator member is pulled initiating the vibratory action of the entire generator member to self-generate electricity.

According to a twelfth aspect, the present invention provides a security device described in any one of the second to ninth aspect, wherein a magnetic force is generated between impact member and the control member, and when a change occurs in the magnetic force as a result of a parting between the control member and the impact member, the control member causes the impact member to impact the piezoelectric element to operate the alarm unit.

With this means, the impact member and the control member are provided with a magnetic material and a magnetic layer or magnet to generate a magnetic force. As the impact member and the control member part from each other, the magnetic attractive force between them changes to pull the impact member or the magnetic repulsive force changes to push the impact member. This initiates the oscillating action of the impact member against the piezoelectric element to self-generate electricity.

To realize the object described above, the security system of the present invention adopts the following means.

According to a thirteenth aspect, the present invention provides a security system which comprises: a security device as described in any one of the first to twelfth aspect; and a detection device installed apart from the security device; wherein the security device issues a first alarm by transmitting a signal to the detection device and the detection device receives the signal to issue a second alarm.

With this means, the security device issues a first alarm by transmitting a signal using the self-generated power to inform the incident to the detection device located at a separate place. Then, the detection device issues a second alarm by annunciating the incident to the surroundings and to a remote location. That is, the security device issues an alarm through the detection device. The second alarm issued from the detection device refers to an annunciation of the incident by generating sound, light and voice or transmitting a signal (including telephone and e-mail). The detection device receives signals from one or more of the security devices.

According to a fourteenth aspect, the present invention provides a security system described in the thirteenth aspect, wherein the detection device issues the second alarm by communicating a notification to an outside world through a network.

With this means, when the detection device receives a signal from the security device, it issues a second alarm to notify the incident to a person at a remote location or an external organization through a selected communication means, such as public telephone network (including mobile communication network) and leased circuits. The external organization includes, for example, police, security company and emergency telephone number of an occupant of the house.

According to a fifteenth aspect, the present invention provides a security system described in the thirteenth or fourteenth aspect, wherein the detection device is controlled from outside to enable or disable the issuing of the second alarm.

With this means, an external control is performed on the detection device to determine whether or not to issue a second alarm after the security device has transmitted a signal to the detection device. This external control is accomplished either by enabling or disabling the reception of a signal from the security device or by enabling or disabling the issuing of the second alarm after having received a signal from the security device.

### BRIEF DESCRIPTION OF THE DRAWINGS

FIG. 1 is an explanatory diagram of a security system of Embodiment 1.

FIG. 2 is a cross-sectional view, as seen from a side, of a security device of the Embodiment 1.

FIG. 3 is a cross-sectional view of a generator member in the security device of the Embodiment 1.

FIG. 4 is a circuit block diagram of the security system of the Embodiment 1.

FIG. 5 is a circuitry of the security device of the Embodiment 1.

FIG. 6 is a circuitry of the security device of the Embodiment 1.

FIG. 7 is an explanatory diagram showing an applied example of the Embodiment 1.

FIG. 8 is an explanatory diagram showing an applied example of the Embodiment 1.

FIG. 9 is an explanatory diagram of a security device of Embodiment 2.

FIG. 10 is an explanatory diagram of a security device of Embodiment 3.

FIG. 11 is an explanatory diagram showing an applied example of the Embodiment 3.

FIG. 12 is an explanatory diagram of a security device of Embodiment 4.

FIG. 13 is a conceptual diagram of a security system of Embodiment 5.

FIG. 14 is an explanatory diagram of a security device of Embodiment 6.

FIG. 15 is a cross-sectional view, as seen from above, of a security device of the Embodiment 6.

FIG. 16 is an explanatory diagram of a security device of Embodiment 7.

FIG. 17 is an explanatory diagram showing an applied example of the Embodiment 7.

### DETAILED DESCRIPTION OF THE PREFERRED EMBODIMENT

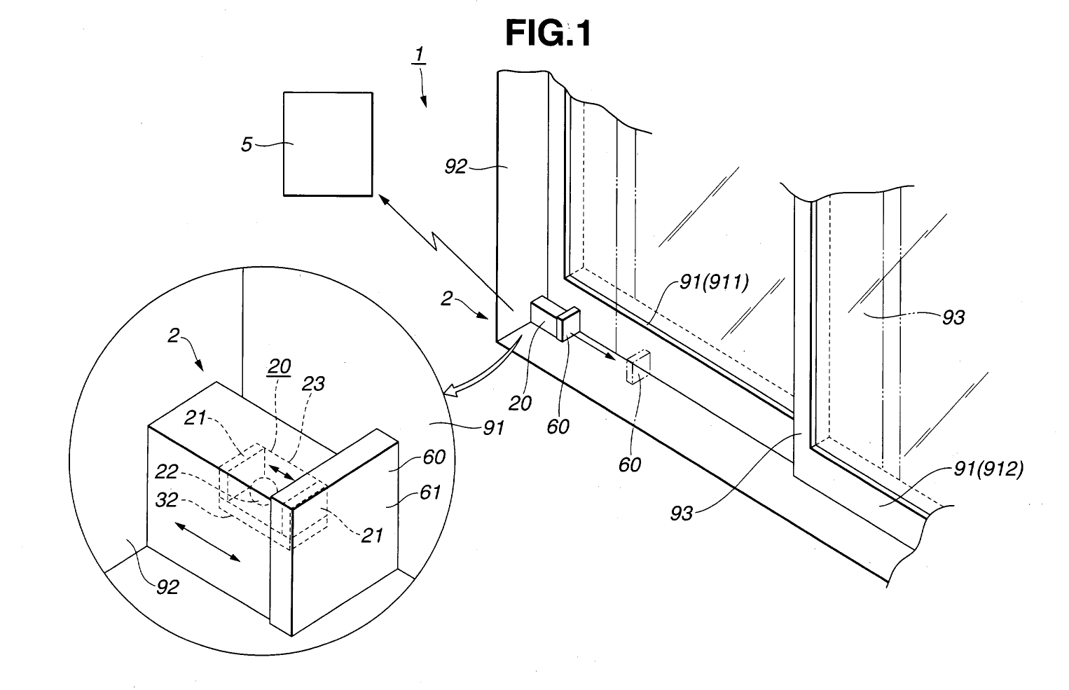

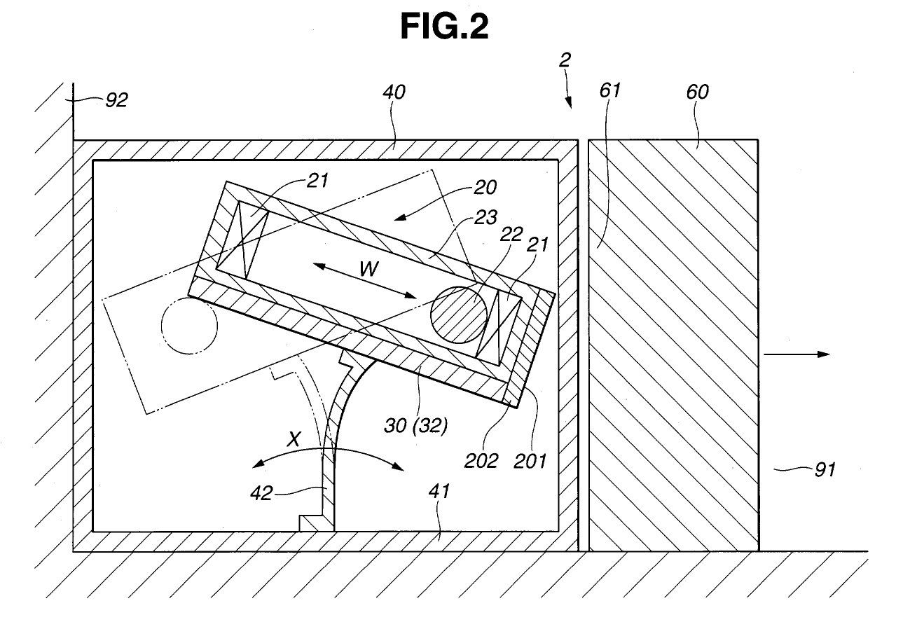

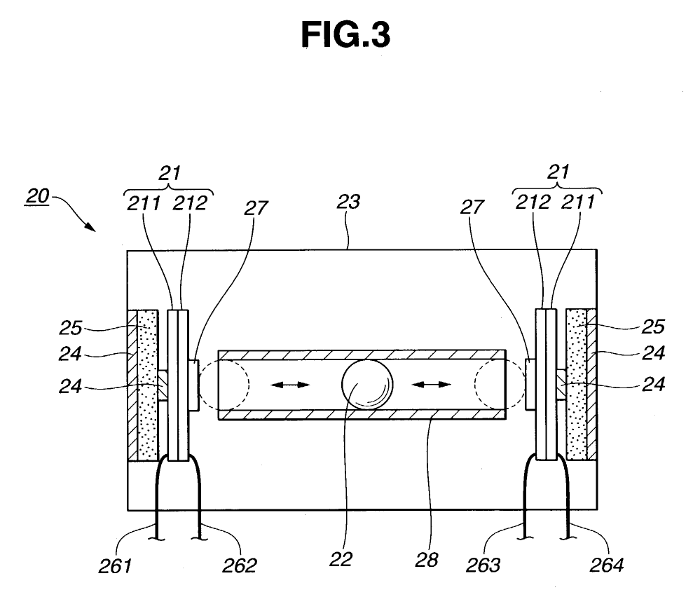

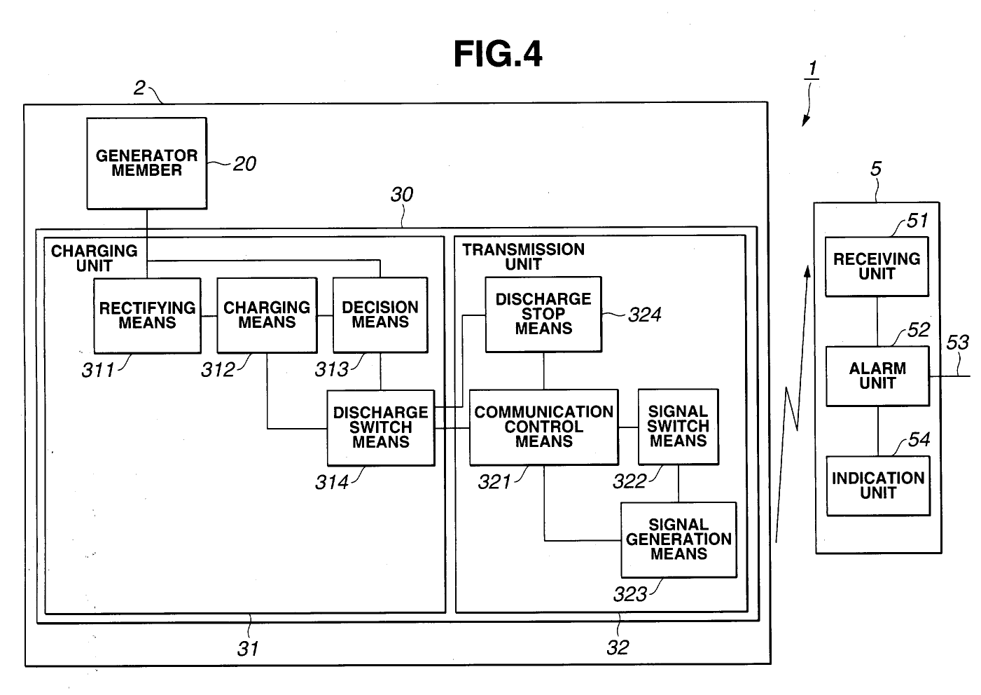

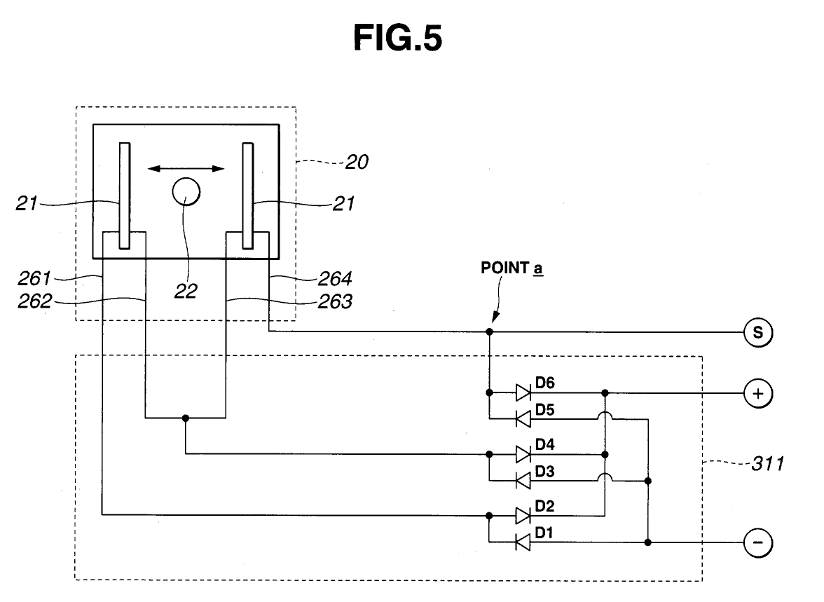

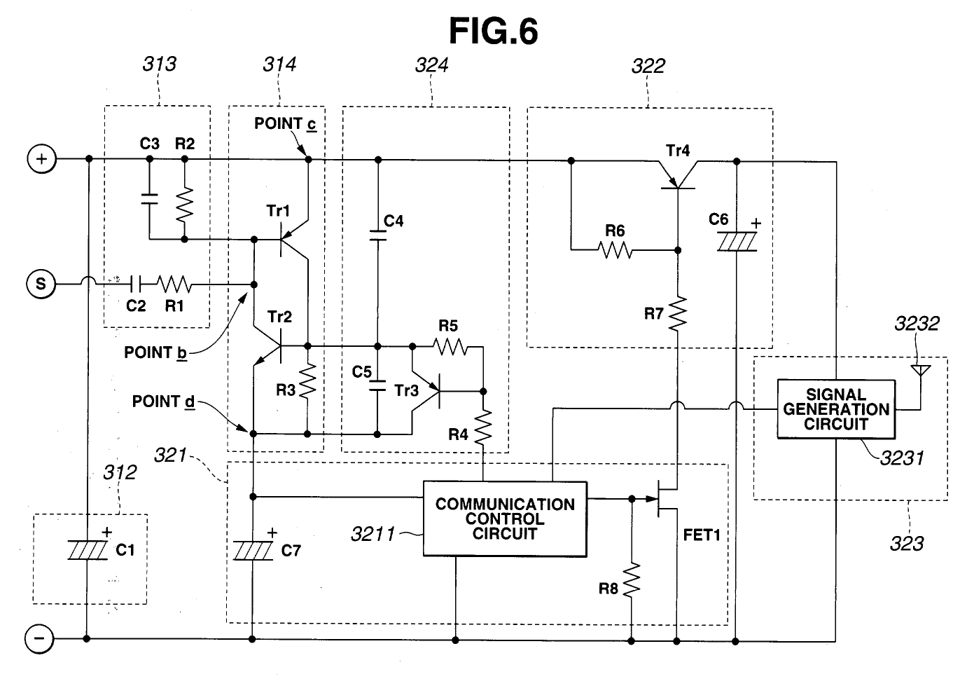

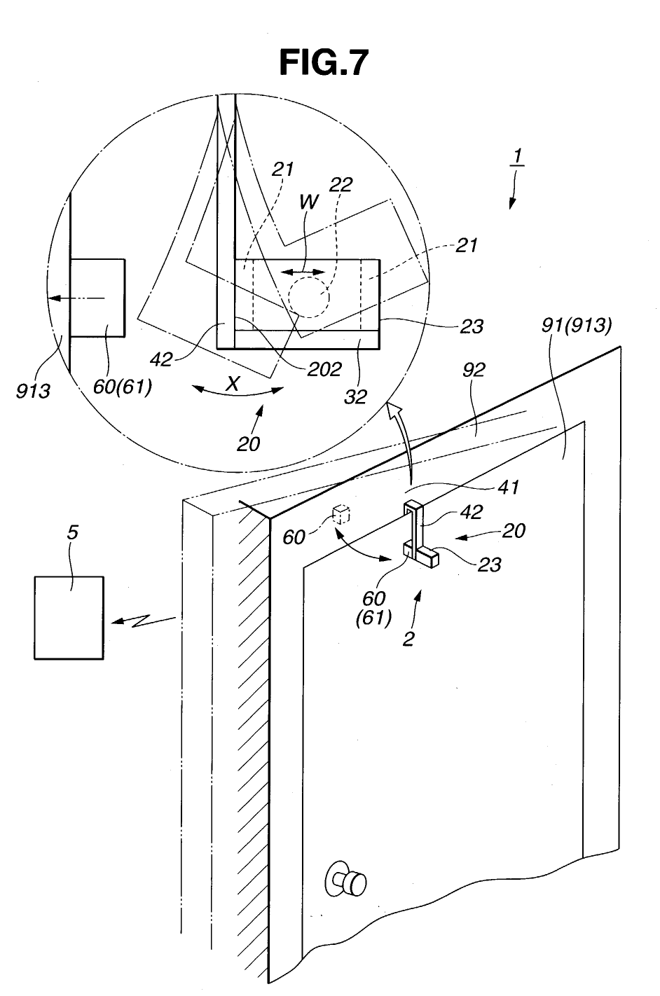

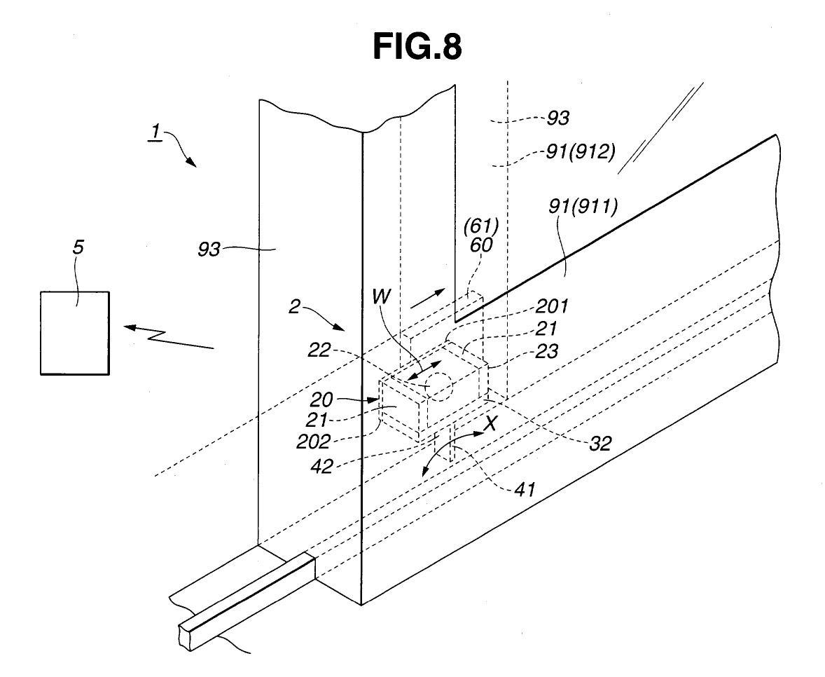

A security device and a security system will be described as Embodiment 1 of this invention by referring to the accompanying drawings. FIG. 1 is an explanatory view showing a security system of the Embodiment 1. FIG. 2 is a cross-sectional view of the security device of the Embodiment 1 as seen from the side. FIG. 3 is a cross-sectional view of a generator member in the security device of the Embodiment 1. FIG. 4 is a circuit block diagram showing the security system of the Embodiment 1. FIG. 5 and FIG. 6 are circuit diagrams of the security device of the Embodiment 1. FIG. 7 and FIG. 8 are example applications of the Embodiment 1.

A security device 2 of the Embodiment 1 has a generator member 20 which comprises piezoelectric elements 21 and an impact member 22 and generates electricity by striking the impact member 22 against the piezoelectric elements 21. When it detects a movement of an object that needs to be monitored for burglary prevention, the security device 2 gives an alarm using the electricity generated by the generator member 20.

The security device 2 of the Embodiment 1 has an alarm unit for issuing an alarm and a control member 60 for deciding whether or not to activate the alarm unit. In the Embodiment 1, the alarm unit is a transmission unit 32 which transmits a signal as a first alarm by using the electricity generated by the generator member 20. A security system 1 has this security device 2 and a detection device 5 that receives the signal from the security device 2 to issue a second alarm. The signal transmitted from the security device 2 propagates through air and, in this example, is a radio signal (electromagnetic signal). This signal may be an ultrasonic signal, optical signal, infrared signal or sound signal.

The security system equipped with the security device 2 and the detection device 5 may execute one of the following three modes of operation. The first mode of operation is that the alarm unit of the security device 2 executes a first alarm to issue a sound, light or voice using the electricity generated by the generator member 20. In this case, the security device 2 does not produce any signal and thus the detection device 5 does nothing at all (does not give a second alarm). The second mode is that the alarm unit executes a first alarm to transmit a signal using the electricity generated by the generator member 20 and then the detection device 5, upon receiving the first alarm signal, executes a second alarm to issue a sound, light or voice or report to a remote location. The third mode is that the alarm unit of the security device 2 executes a first alarm to issue a sound, light or voice and at the same time transmit a signal using the electricity generated by the generator member 20 and then the detection device 5, upon receiving the first alarm signal, executes a second alarm to issue a sound, light or voice or report to a remote location. In the Embodiment 1, the second mode of operation will be described but any other mode may also be applied.

In the security device 2 of the Embodiment 1, a magnetic force is formed between the generator member 20 and the control member 60. In a normal condition the generator member 20 and the control member 60 are attracted to each other so that no electricity is generated by the generator member 20. When the magnetic attraction between them is lost as a result of displacement of the control member 60 caused by a break-in, the generator member 20 starts generating electricity and the transmission unit 32 as the alarm unit transmits a signal.

As shown in FIG. 1, the security device 2 has either the generator member 20 or the control member 60 attached to a sliding door or window 91 and the other attached to a nearby member 92 which parts from the door 91 as the door 91 is opened. The door 91 may be any kind of door that has a possibility of being broken into by a burglar, such as a hinged door, a sliding door, a glazed window, a rain protection sliding shutter, a door of a safe or container and a cover. The nearby member 92 may be set at any location as long as the selected location parts from the door 91 when the door 91 is opened. As an example location of the security device 2 which does not hinder the open-close operation of the door or window and is hardly seen from outside, FIG. 1 shows the control member 60 attached to a lower end of a sliding glazed window 911 on the indoor side and the generator member 20 mounted on a frame of the window 911 on the indoor side. This window frame is stationary, so that when the sliding glazed window 911 is opened, the generator member 20 and the control member 60 part from each other.

The detection device 5 can be installed at any appropriate locations. Among them are a location where it is separated from the security device 2 and not easily seen, a location where the power supply is readily available and the detection device 5 can be managed easily and a location where an alarm, such as sound and light, can easily be noticed. More specifically, in a single-family house the detection device 5 is usually installed in a living room or kitchen; and in a building it may be installed in a management office. It is noted, however, that the installation location is not limited to these examples. The detection device 5 can receive signals from one or more security devices 2. When signals from a plurality of security devices 2 are received, each signal has its own identification information that indicates from which security device 2 the signal has been transmitted. The second alarm issued by the detection device 5 annunciates a break-in either to a surrounding area or to a remote location. An alarm issued to the surroundings includes, for example, a sound (e.g., siren), a voice (a stern warning and voices indicating the presence of people in the home) and light. An alarm issued to a remote location includes a reporting to police or a security company through a network 53 or to a cell phone of a home owner or an alternate phone number for emergencies. The network 53 may be various communication means including a public telephone network (including mobile communication network) and leased circuits. The reporting may be done not only by telephone but also through Internet and e-mail. Here, the alarm is issued both to surroundings and to a remote location. It is noted, however, that the alarm may be issued to only one of them.

The detection device 5 is controlled externally to enable or disable the execution of the second alarm. The external control is performed by a remote control on the detection device 5. This may be done by accessing it through telephone (or e-mail). Each time the door 91 is opened, the security device 2 dispatches a signal as the first alarm from the transmission unit 32. Hence, the signal is transmitted not only when the door 91 is opened by a burglar but also when it is opened by a family member. To deal with this situation, the detection device 5 enables or disables the execution of the second alarm so as to execute the second alarm only in the event of a break-in. This enable/disable control may be performed by enabling or disabling a reception of a signal from the security device 2 or by enabling or disabling an execution of the second alarm after having received a signal from the security device 2. Here, it is assumed that the latter control is adopted. Suppose, for example, the security device 2 is installed on the front door. Immediately after a family member has closed and locked the door, he or she operates a remote control on the detection device 5 outside the house to enable the detection device 5 to execute the second alarm. When the family member returns home, he or she operates the remote control from outside the house to disable the detection device 5 from executing the second alarm.

One example construction of the security device 2 is shown in FIG. 2. The invention is not limited to this construction. The generator member 20 is accommodated in a case 40 which is secured to a nearby member 92 by an appropriate means not shown (such as a bonding agent, a double-sided adhesive tape and screws). The control member 60 has a magnet 61 which is secured to the door 91 by an appropriate means not shown (such as a bonding agent, a double-sided adhesive tape and screws). The case 40 is formed of a magnetically permeable material and shaped into any desired geometry, for example, a cuboid in this case. This case 40 is provided for the protection of the generator member 20 and thus may be omitted.

The generator member 20 comprises a housing 23 accommodating the piezoelectric elements 21 and the impact member 22, a base portion 41 for supporting the housing 23, and an elastic member 42 connecting the housing 23 to the base portion 41 and having an elasticity for vibrating the housing 23 to cause the impact member 22 to repetitively strike against the piezoelectric elements 21. A bottom of the case 40 serves as the base portion 41. A magnetic metal plate as a magnetic layer 201 is bonded to a side surface 202 of the generator member 20 that opposes the magnet 61. The bonded magnetic layer 201 may be provided in the form of a magnetic film, instead of the metal plate. A magnetic force acting between the magnetic layer 201 and the magnet 61 causes the generator member 20 and the control member 60 to be attracted to each other. The elastic member 42 is mounted on the base portion 41 and protrudes upward to connect the generator member 20 to the base portion 41. The housing 23 has a circuit unit 30 including the transmission unit 32. The elastic member 42 has an elasticity and, when the magnet 61 is close to the generator member 20, the magnetic layer 201 of the generator member 20 is attracted to the magnet 61, with the entire generator member 20 kept tilted toward the magnet 61 (with the elastic member 42 elastically deformed out of balance). In this state, the impact member 22 is simply in contact with the piezoelectric element 21 and does not produce any deformation nor electricity. When the magnet 61 parts from the generator member 20 to release the magnetic layer 201 from the attractive force, the elastic member 42 recovers from the tilted state by its elasticity causing the generator member 20 to oscillate. This in turn causes the impact member 22 to strike against the piezoelectric elements 21, starting to generate electricity. Where the case 40 is omitted, a positional relation may be employed in which the elastic member 42 is in a neutral state when the door 91 is closed and the magnet 61 is close to the generator member 20 so that the generator member 20 is attracted to the magnet 61.

Constructions of individual components will be described in more detail. The construction of the generator member 20 will be explained with reference to FIG. 3. The impact member 22 is contained in the housing 23 so that it is rolled to strike against the piezoelectric elements 21, provided to the opposite inner walls of the boxlike housing 23. The impact member 22 is shaped like a ball. Each of the piezoelectric elements 21 has two piezoceramic plates 211, 212 of PZT (lead zirconium titanate) bonded together with their polarities set in opposite directions so that a canceling effect due to polarization in a series-connected generation circuit can be prevented to enhance the generation performance. The piezoelectric element 21 is partially bonded to a central part or end portions of a platelike cushion material 25 with an adhesive 24 (other fixing methods than bonding may be used). The cushion material 25 is secured to the housing 23 with the adhesive 24. This arrangement protects the piezoelectric elements 21 from the impacts of the impact member 22 and allows the piezoceramic plates 211, 212 to continue oscillation, enhancing the generation performance. Filmlike electrodes (not shown) formed on the front and back surfaces of the piezoelectric element 21 are each connected with a lead wire 261-264 that is drawn out to a circuit unit 30. A thin plate protector 27 is secured to the surface of the piezoelectric element 21 (the surface against which the impact member 22 strikes) to protect the piezoelectric element 21 from the impact. Installed between the opposing piezoelectric elements 21 is a guide 28 which restricts the direction of rolling motion of the impact member 22 and thereby guides it to impact precisely that part of the piezoelectric element 21 where the protector 27 is secured. As the guide 28 a cylindrical guide is shown here. It may be partition plates.

As for materials of individual members, the piezoceramic plates 211, 212 most suitably use lead zirconium titanate materials but may use other materials. It is preferred that the piezoceramic plates 211, 212 be as hard and have as high a Q-factor as possible to maintain oscillations of long duration and thereby generate an increased amount of electricity. More specifically, the Q-factor is preferably 1,000 or higher and, more preferably, 2,000 or higher. The cushion material 25 may suitably use synthetic resin, rubber or a soft spongy material made of these. One such example is foamed polyethylene. The impact member 22 suitably use materials that, for an improved generation efficiency, are heavy to such an extent as will not destroy the piezoelectric element 21. Examples of such materials include tungsten and iron. As for materials of the protector 27, hard metals and synthetic resins are suited, such as phosphor bronze and stainless steel. Phosphor bronze with a good machinability is particularly preferred.

The construction of the generator member 20 and the method of causing the piezoelectric elements 21 to generate electricity are not limited to the above. While in the Embodiment 1 the piezoelectric elements 21 of the generator member 20 are provided at two opposing locations, with the impact member 22 reciprocally moving between the piezoelectric elements 21, 21, the piezoelectric element 21 may be provided at only one location or at three or more locations. Further, two impact members may be used, which is disclosed by this inventor in Japanese Patent Laid-Open No. 2001-145375, and the impact member may be suspended by a spring material. Further, a metal plate, whose thickness is coordinated to produce a distortion corresponding in magnitude to that of a single-layer piezoceramic plate 211, may be bonded to the same piezoceramic plate and then struck with the impact member 22.

Next, the elastic member 42 will be described in more detail by referring to FIG. 2. The elastic member 42 is secured at its ends to the housing 23 and the base portion 41 with an appropriate means (e.g., bonding and fusing). The elastic member 42 is made from an elastic material having a directivity in its spring constant and is connected to the generator member 20 such that a direction of the smallest of spring constants of the elastic member 42 agrees with a direction in which the impact member 22 strikes the piezoelectric element 21 (hereinafter referred to as an impact direction). That is, if, of the spring constants in X, Y and Z directions of the elastic member 42, the smallest spring constant has an X direction, the elastic member 42 is attached to the housing 23 so that the direction of the arrow X matches the direction of impact (direction of arrow W in FIG. 2) as shown in FIG. 2. Although in the construction shown in FIG. 2, the bottom of the housing 23 is connected with the elastic member 42, the elastic member 42 may be connected to the side or any other portion of the generator member 20 as long as the direction of the least spring constant of the elastic member 42 matches the impact direction.

Further, a spring constant of the elastic member 42 in the impact direction is selected which will make the period of oscillation of the generator member 20 as small as possible. By reducing the oscillation cycle of the generator member 20, the number of impacts made by the impact member 22 against the piezoelectric element 21 per unit time can be increased, which in turn increases the amount of electricity produced as a whole. To reduce the cycle requires reducing a mass of the generator member 20 and increasing the spring constant. A spring constant is chosen which will make the oscillation cycle as small as possible to ensure a reliable oscillation when the control member 60 parts from the generator member 20 and the magnetic attraction is lost. In the Embodiment 1, also by forming the base portion 41 robust so that it is sufficiently larger in mass than the entire housing 23 combined with the elastic member 42, an attenuation of vibrations due to a parasitic vibration can be reduced. It is also possible to reduce the attenuation of vibrations due to a parasitic vibration by the following arrangement. That is, rather than being held immovable in the form of the bottom of the case 40, the base portion 41 may be arranged so that its natural vibration resonates with a natural vibration produced by the generator member 20 and the elastic member 42.

In the Embodiment 1, a leaf spring is used as an elastic material for the elastic member 42. The leaf spring is an elastic body that has a directivity in the spring constant and has a particularly small spring constant in one direction. Thus, the leaf spring is secured to the generator member 20 so that the direction in which the leaf spring is deflected most easily (X direction) is aligned with the impact direction (W direction). The spring constants in Y and Z directions of the leaf spring, when compared to that of the X direction, are close to infinity. Therefore, not matter in which direction the magnet 61 parts, the elastic member 42 does not produce any displacement in the Y and Z directions crossing the impact direction (i.e., a direction in which the impact member 22 strikes against the sides of the housing 23 where the piezoelectric elements 21 are not provided and a direction in which the generator member 20 displaces vertically), with the result that vibrations that may hinder the motion of the impact member 22 in the impact direction are not easily generated. Further, since the elastic member 42 is flexible and easily deformed in only the X direction, any movement can easily be translated into a motion in the X direction, in whatever direction the magnet 61 moves. As described above, the leaf spring is suitable for generating vibrations in the impact direction and sustaining them.

In addition to the leaf spring described above, the elastic member 42 may use rubber materials (e.g., silicone rubber), gel materials (e.g., heat reversible elastomer), foamed materials, and low-Young's modulus Ti alloys (Ti alloys with large elastic deformations). These rubber and gel materials may be formed into a desired shape with appropriate length, width and height to produce a desired directivity in the spring constant or change the spring constant. A coil spring may be used for the elastic member 42. In that case, it is desired that the generator member 20 be supported in a restrictive manner to ensure that the impact member 22 moves only in the impact direction.

Next, a circuit of the security system 1 will be described by referring to FIG. 4 to FIG. 6. As shown in a block diagram of FIG. 4, an output of the generator member 20 is drawn out to the circuit unit 30. The circuit unit 30 has a charging unit 31 for rectifying an AC current generated by the generator member 20 and charging it and the transmission unit 32. A signal transmitted as a first alarm from the transmission unit 32 is received by a receiving unit 51 of the detection device 5. An alarm unit 52 in the detection device 5 then annunciates a second alarm to the surroundings in the form of sound and light and at the same time communicates the second alarm to a predetermined remote location through the network 53. The issuing of the second alarm from the alarm unit 52 is enabled or disabled from outside. An indication unit 54 indicates from which of the security devices 2 the signal was received (as by flashing a lamp or lighting a red lamp).

The charging unit 31 of the circuit unit 30 has a rectifying means 311, a charging means 312, a decision means 313, and a discharge switch means 314. The rectifying means 311 rectifies the AC current output from the generator member 20 into a ripple current. The charging means 312 stores the ripple current obtained from the rectifying means 311 as a DC charge. The decision means 313 monitors the amount of charge of the charging means 312 intermittently according to the generation timing of the piezoelectric elements 21. The decision means 313 consumes a very small amount of charge during the monitoring operation, but since the monitoring is done only intermittently, the power consumption is minimal, having little effect on the charge volume. When the decision means 313 decides that the amount of charge of the charging means 312 has reached a level of transmission, the discharge switch means 314 starts discharging the charging means 312 to supply electricity to the transmission unit 32.

The transmission unit 32 has a communication control means 321, a signal switch means 322, a signal generation means 323, and a discharge stop circuit 324. The communication control means 321 performs operations necessary for communication and is started when it is supplied a power from the charging unit 31. When started, the communication control means 321 turns on the signal switch means 322 and at the same time transfers transmission data to the signal generation means 323. The signal switch means 322 is turned on by the communication control means 321 and supplies electricity to the signal generation means 323. The signal generation means 323 converts the transmission data received from the communication control means 321 into a signal and transmits the converted signal. The discharge stop circuit 324 operates the discharge switch means 314 to stop the power supply from the charging unit 31. The discharge stop circuit 324 is activated by the communication control means 321 when the communication control means 321 has transferred all transmission data to the signal generation means 323.

Referring to FIG. 5 and FIG. 6 further explanation will be given. FIG. 5 and FIG. 6 show circuits connected together through points S, + and −. The rectifying means 311 has diodes D1-D6 that form a full-wave rectifying circuit, which rectifies the AC power output from the generator member 20 into a ripple current for output to subsequent circuits. Of four lead wires 261-264 drawn out from the generator member 20, the lead wires 262, 263 are connected together and a total of three lead wires are connected to the six diodes D1-D6. Although the circuit shown here connects the lead wires 262, 263 to reduce the number of diodes, all the four lead wires may be connected to eight diodes, without connecting the lead wires 262, 263, to form a full-wave rectifying circuit.

The charging means 312 has a capacitor C1. The capacitor C1 may be replaced with a rechargeable battery. The ripple current from the rectifying means 311 is charged as a DC power to the capacitor C1. Each time the impact member 22 strikes against the piezoelectric elements 21 to generate electricity, the voltage across the capacitor C1 increases.

The discharge switch means 314 uses a self-hold type current switch. In the Embodiment 1, a complementary transistor is used which has a combination of a PNP transistor Tr1 and an NPN transistor Tr2. In this discharge switch means 314, when a voltage about 0.6 V (a value determined by Tr1) lower than a voltage of point c is applied to a point b, Tr1 is turned on, followed almost simultaneously by Tr2 turning on. With the discharge switch means 314 turned on, an impedance between point c and point d becomes extremely low. Then, the power stored in the capacitor C1 of the charging means 312 is discharged and supplied to the communication control means 321 with a very small loss. This ON-state self-holds and continues until the discharge stops.

The decision means 313 has capacitors C2, C3 and resistors R1, R2. C3 is provided for preventing erroneous operations. The capacitor C2 and the resistor R1 are provided between an output of the piezoelectric elements 21 or point a in FIG. 5 and point b of the discharge switch means 314 in FIG. 6. This time constant determines a duration during which a voltage is applied to the point b when making a decision on the amount of charge. At point a an AC voltage is generated each time the impact member 22 strikes the piezoelectric elements 21. This voltage is a forward voltage of a diode D6 added to a terminal voltage of the capacitor C1. Then, as the voltage of the capacitor C1 is increased by charging, the AC voltage at point a also increases. That is, at point a the AC voltage almost proportional to the DC voltage across the capacitor C1 is produced each time the impact member 22 impinges, i.e., intermittently. The AC voltage at point a is applied to point b for a short duration determined by the time constant of the resistor R1 and the capacitor C2. The voltage at point b is determined by a distribution ratio of the resistors R1 and R2. When the voltage at point b exceeds a voltage value, which is about 0.6 V (determined by Tr1) lower than the voltage at point c, the discharge switch means 314 turns on, as described above. Here, since the voltage at point b is given by “voltage at point c×(1−R2/(R1+R2))”, the time when the voltage at point b is equal to a voltage about 0.6 V lower than the voltage at point c or “voltage at point c−about 0.6 V” constitutes a decision threshold which is used to determine the level of charge. Hence, by adjusting R1 and R2 it is possible to adjust the amount of charge at which to initiate a discharge to a level at which a signal can be transmitted. This level is set for each signal to be transmitted. While the point a is shown located on the side of the lead wire 264 in this example, it may be provided on the side of the lead wire 261 or on the side of the connected lead wires 262, 263. Further, while in this example, the decision is made at each timing when one of the two piezoelectric elements 21 generates electricity, it is also possible to make a decision at a timing when both of the piezoelectric elements 21 generate electricity or every nth timing (n is an arbitrary integer) that the piezoelectric elements 21 generate electricity.

The communication control means 321 has a communication control circuit 3211, a capacitor C7, a resistor R8 and a FET1. The capacitor C7 is provided for stabilizing the operation. The resistor R8 and FET1 are provided for level conversion to establish a low-power consumption interface between the communication control circuit 3211 and the signal switch means 322. When the discharge of the charging unit 31 supplies power to the communication control circuit 3211, the communication control circuit 3211 initiates a necessary procedure for transmission. The communication control circuit 3211 has a small power consumption.

The signal switch means 322 has a PNP transistor Tr4, resistors R6, R7 and a capacitor C6. Since a signal generation circuit 3231 requires a relatively large power, the signal switch means 322 uses the large power transistor switch Tr4 to supply power to the signal generation circuit 3231. When a transmission start command from the communication control circuit 3211 passes through the FET1 and resistor R7 and turns on the transistor Tr4, the signal switch means 322 causes the signal generation means 323 to start transmission.

The signal generation means 323 has a signal generation circuit 3231 and an antenna 3232. When it is supplied power from the signal switch means 322, the signal generation means 323 converts transmission data received from the communication control circuit 3211 into a radio signal and transmits it from the antenna 3232.

The discharge stop means 324 has a PNP transistor Tr3, resistors R4, R5, and capacitors C4, C5. The capacitors C4, C5 are provided for preventing erroneous operations. When the communication control circuit 3211 finishes sending the transmission data to the signal generation circuit 3231, the communication control circuit 3211 outputs a signal through the resistor R4 to the transistor Tr3 to turn it on. With the transistor Tr3 turned on, the discharge switch means 314 is released from the self-holding state, stopping the discharge of the power stored in the capacitor C1 and therefore the transmission operation.

Now, the operation of the security system 1 of the Embodiment 1 constructed as described above will be described. Here, we take up as an example a case where the security device 2 is installed on a front door of a house and on windows of each room and the detection device 5 is located in a living room of the house.

First, an occupant of the house installs the security device 2 on doors or windows and their associated members through which he or she thinks a burglar may break in. Since the security device 2 does not require wiring for power supply, it can be readily installed even at locations remote from electrical outlets or where circuits are not easily wired. As one of these devices is shown in FIG. 1, a magnet 61 of the control member 60 of the security device 2 is mounted on a window 91 and a case 40 containing the generator member 20 is attached to a nearby member 92 so that the generator member 20 opposes the magnet 61 when the window 91 is closed. A signal transmitted from each security device 2 has its own identification information. When it receives a plurality of signals, the single detection device 5 uses this identification information to determine from which device the signal was transmitted. The indication unit 54 of the detection device 5, upon receiving a signal from the security device 2, lights up the corresponding lamp marked with “front door”, “window of living room” or “window of bedroom” to indicate the break-in location.

When family members are in the house, the detection device 5 is remotely controlled so that even if the front door or window 91 is opened and a signal is received from the security device 2, the detection device 5 will not execute the second alarm. When the family members leave the house, they remotely operate the detection device 5 so that it is enabled to execute the alarm. If there is no possibility of the family members causing the security device 2 to transmit a signal, it is also possible to enable the detection device 5 at all times to execute the second alarm.

When the family members are not at home and a burglar opens a window of a living room, the magnet 61 parts from the generator member 20. This releases from a magnetic force the generator member 20, which has been attracted to the magnet 61 of the control member 60, allowing the generator member 20 to start vibrating because of the elastic force of the elastic member 42, as shown in FIG. 2. This vibration causes the impact member 22 to strike against the piezoelectric elements 21 to generate electricity. Further, the elasticity of the elastic member 42 keeps the generator member 20 oscillating, causing the impact member 22 to roll and repeat its impinging action against the piezoelectric elements 21. That is, as the magnet 61 parts from the generator member 20, the generator member 20 continually vibrates to generate electricity.

A power thus generated is supplied from the generator member 20 to the circuit unit 30. The circuit unit 30 picks up an AC voltage from an output of the piezoelectric elements 21 each time a power is generated. The amount of accumulated charge is checked by the decision means 313. This intermittent monitoring and decision on the amount of charge is performed efficiently at a timing when the amount of charge increases. Further, since the power consumption by the accumulated charge level check is kept to a minimum, the power required for transmission can be quickly accumulated and supplied to the transmission unit 32. As a result, immediately after the window 91 is opened, the transmission unit 32 issues a signal.

The signal transmitted from the transmission unit 32 is received as a first alarm by the receiving unit 51 of the detection device 5. Upon receipt of the first signal, the alarm unit 52 executes the second alarm. The second alarm issues a warning to the burglar with sound, light or voice or gives noise indicating the presence of family members, thereby prompting the burglar to run away. At the same time, this incident is reported through the telephone network 53 to police and also to the resident away from home.

As described above, in the Embodiment 1 since the security device 2 self-generates electricity, it can be installed at any desired location without being troubled by the need to supply power to the security device 2. Further, since it requires no wiring and is small in size, the security device 2 is not easily noticed, which in turn enhances its reliability. Moreover, if the security device 2 is installed at all locations where there is a possibility of break-in, the economical burden is significantly reduced because it uses no utility power while in service.

The security device 2 may have its generator member 20 mounted on the sliding window 911 and the control member 60 on the nearby member 92, as opposed to the arrangement shown in FIG. 1. Further, in the case of double sliding windows 911, 912 as shown in FIG. 1, one of them may be regarded as a nearby member for the other. When one or both of the windows 911, 912 are opened, the overlapping sides 93, 93 of the two windows move away from each other. Thus, it is desired that the generator member 20 be mounted on one of the sides 93, 93 and the control member 60 on the other. This also applies to hinged double doors as well as to the double sliding doors.

FIG. 7 and FIG. 8 show applied examples of the security device 2 of the Embodiment 1. FIG. 7 shows a security device 2 attached to a front door 913 as the door 91. In the figure, the magnet 61 of the control member 60 is attached to the door 913 and the generator member 20 is mounted to an upper frame of the door 913 as the nearby member 92. One end of the elastic member 42 made of a leaf spring is attached to a side surface 202 of the housing 23 of the generator member 20; and the other end is attached to the nearby member 92, with the housing 23 suspended by the elastic member 42 on the side of the door 913. The leaf spring of the elastic member 42 is made of steel and thus has a magnetic permeability, so the magnetic layer 201 is not bonded to the generator member 20. In this construction, when the door 913 is closed, the magnet 61 and the elastic member 42 of the generator member 20 are magnetically attracted to each other. When the door 913 is opened, the elastic member 42 begins to be deformed, with the generator member 20 still clinging to the magnet 61. When the door 913 is opened more than a specified angle, the magnet 61 separates from the generator member 20 allowing it to snap back and enter into the oscillation state. As a result, the generator member 20 self-generates electricity, causing the transmission unit 32 to issue an alarm signal.

FIG. 8 shows a security device 2 installed inside a sliding window 91. The window 91 is, for example, an aluminum sash window, with the generator member 20 and the control member 60 installed in an inner space formed in the sash portion. As shown in FIG. 8, the window 91 consists of sliding glazed windows 911, 912. The generator member 20 and the magnet 61 of the control member 60 are installed in the sliding window 911 and the sliding window 912, respectively, near the overlapping sides 93, 93. A side surface 202 of the generator member 20 that faces the magnet 61 is attached with a magnetic layer 201 which is magnetically attracted to the control member 60. When one or both of the sliding windows 911, 912 are opened, the magnet 61 starts moving away from the generator member 20 and the elastic member 42 deforms toward the moving magnet 61 until the magnetic force is no longer strong enough, at which time the generator member 20 begins to oscillate. The generator member 20 now self-generates electricity, which in turn causes the transmission unit 32 to issue an alarm signal. In this configuration, the security device 2 may be formed as a product already incorporated into the window 91.

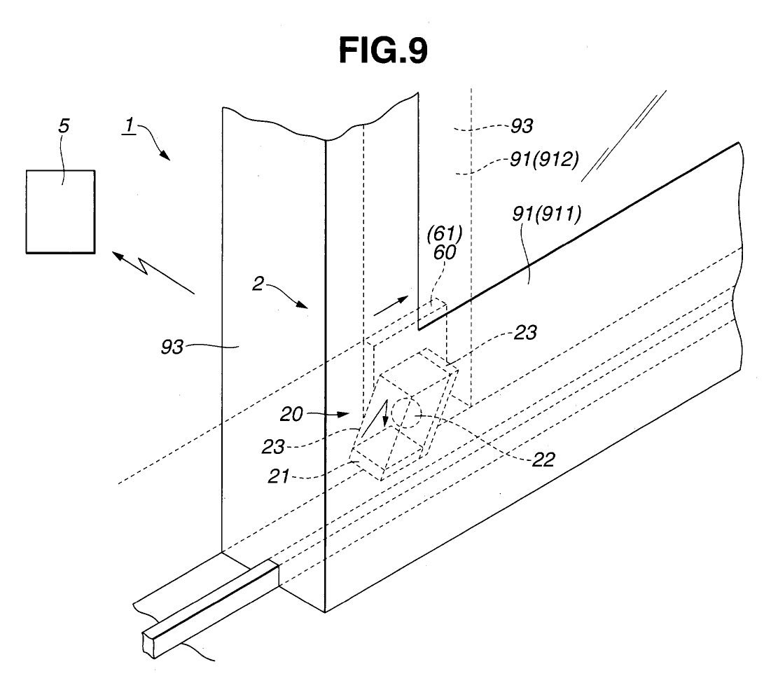

Next, a security device of Embodiment 2 according to the present invention will be described by referring to the drawings. FIG. 9 is an explanatory diagram of the security device of the Embodiment 2. Parts that are identical with those of the Embodiment 1 are given like reference numbers and their explanations are omitted.

Unlike the Embodiment 1 in which the magnetic layer 201 is formed on the side surface of the generator member 20, the security device 2 of the Embodiment 2 is characterized in that the impact member 22 of the generator member 20 is formed of a magnetic material.

In the Embodiment 2, since the piezoelectric elements 21 have a high generation efficiency and the transmission unit 32 can transmit a signal even if the impact member 22 does not repeat the impinging action, the elastic member 42 is omitted.

FIG. 9 shows the security device 2 installed inside the window 91 as in FIG. 8. The generator member 20 is installed inside the sliding window 911 and the magnet 61 of the control member 60 in the sliding window 912, both near their overlapping sides 93, 93. The housing 23 of the generator member 20 is formed like a cuboid which is inclined upward toward the direction in which the sliding window 912, when opened, moves. Inside the housing 23, the piezoelectric element 21 is arranged on the bottom side. When the window 91 is closed, the impact member 22 rests on the piezoelectric element 21. In this state, the piezoelectric elements 21 is not deformed and thus no electricity is generated. As one or both of the sliding windows 911 and 912 are opened and the control member 60 formed of the magnet 61 starts to move away from the generator member 20, the impact member 22 of a magnetic material moves up the inclined housing 23 in the same direction that the control member 60 is moving, until the magnetic force is no longer strong enough, at which time the impact member 22 falls onto the piezoelectric element 21. As a result, the piezoelectric element 21 self-generates electricity causing the transmission unit 32 to issue a first alarm. In this configuration, the security device 2 may be formed as a product already incorporated into the window 91.

Compared with the Embodiment 1, the Embodiment 2 has an advantage of being able to reduce the number of parts. Other operations and advantages are similar to those of the Embodiment 1.

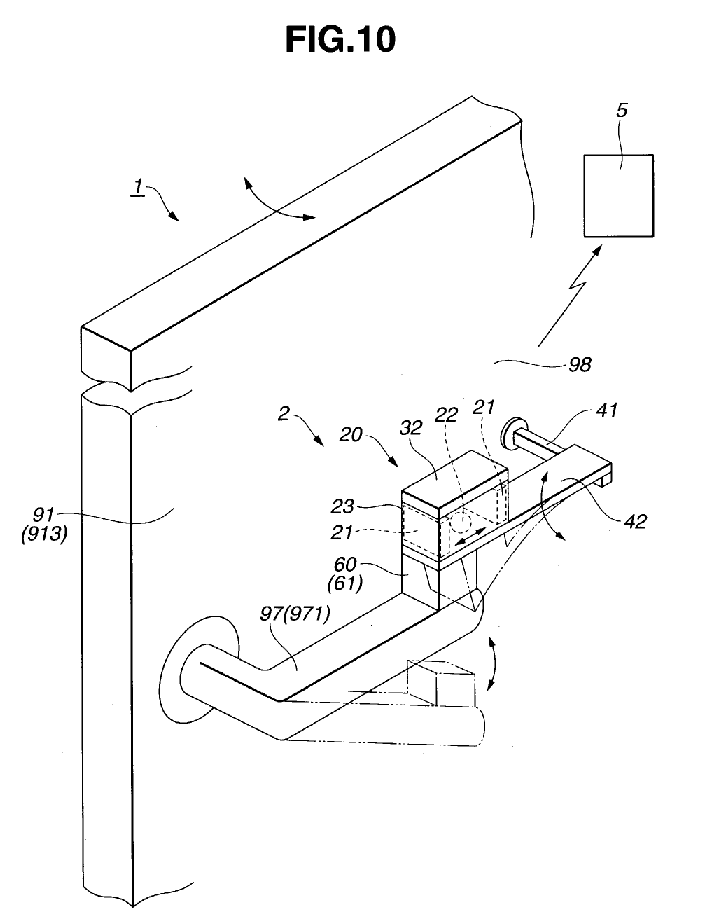

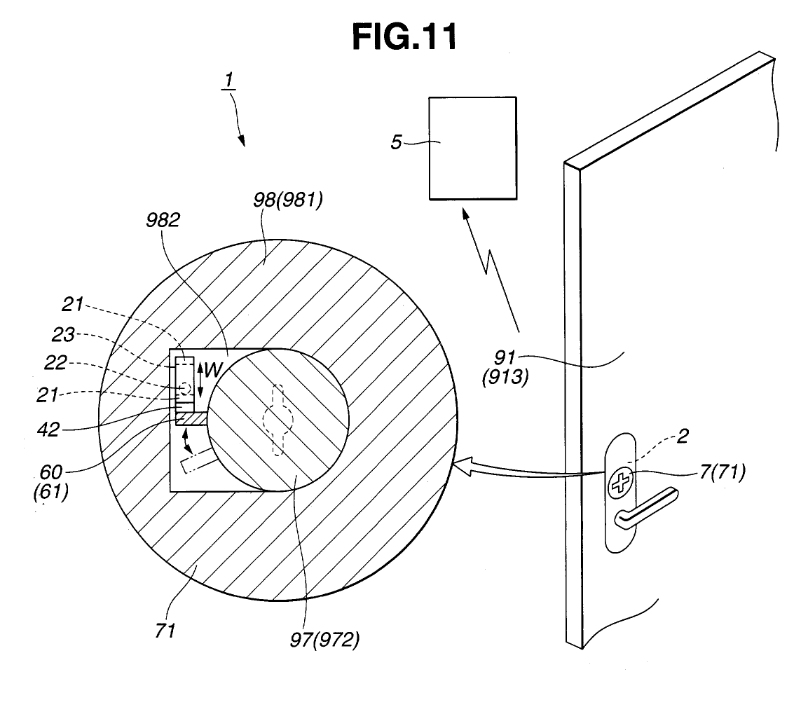

Next, a security device of Embodiment 3 according to the present invention will be described by referring to the drawings. FIG. 10 is an explanatory view of the security device 2 of the Embodiment 3, and FIG. 11 illustrates an applied example of the Embodiment 3. Parts identical with those of the Embodiment 1 are given like reference numbers and their detailed explanations are omitted.

In the Embodiment 1 and 2, the security device 2 has been described to be attached in one part to the window 91 and in another part to the nearby member 92. In Embodiment 3 the security device 2 is characterized in that one of the generator member 20 and the control member 60 is mounted to a moving portion 97 that is displaced when the door or window 91 is opened and that the other is mounted to a nearby portion 98 that parts from the moving portion 97 when the door is opened. Other structural aspects are similar to those of the Embodiment 1 shown in FIG. 3 to FIG. 6 or to those of the Embodiment 2.

FIG. 10 shows the security device 2 attached to a door handle 971, as the moving portion 97, of a front door 913. In the figure, as the moving portion 97 the door handle 971 on the inner side of the door 913 is used, and the magnet 61 of the control member 60 is attached to the end of the door handle 971. As the nearby portion 98 that parts from the moving portion 97, the door 913 is used. The elastic member 42 is secured at one end to a base portion 41 protruding inwardly from the door 913 and at the other end to the housing 23, thereby mounting the generator member 20 to the door 913. The elastic member 42 is formed of a leaf spring that has a magnetic permeability, so a magnetic layer is not provided on the generator member 20. The housing 23 opposes the magnet 61 with the elastic member 42 in between and is attracted to the magnet when the door 913 is closed.

In this configuration, when the door handle 971 is turned downward to open the door 91, the magnet 61 also moves along with the door handle 971. The magnet 61 starts moving away from the generator member 20 and at the same time the elastic member 42 also deforms in the same direction that the magnet 61 is moving. When the control member 60 moves farther than the limit of deformation of the elastic member 42, the generator member 20 snaps back and starts oscillating to self-generate electricity, causing the transmission unit 32 to issue a first alarm signal.

The door handle 971 is not limited to the shape shown in FIG. 10 and may take any other shape such as a nearly spherical one. In addition to the door handle 971, the moving portion 97 may be applied to an inner part of a lock 7 that is rotated to unlock the door and to a door closer whose two-folded member opens or closes as the door is opened or closed. FIG. 11 shows the security device as applied to a cylinder lock 71. Detailed structure of the cylinder lock 71 is not shown. The cylinder lock 71 has an inner cylinder 972 and an outer cylinder 981. When a key is inserted and turned to unlock the door 913, the inner cylinder rotates. Thus, in FIG. 11, the inner cylinder 972 of the cylinder lock 71 is used as the moving portion 97 and the outer cylinder 981 as the nearby portion 98. The magnet 61 of the control member 60 is projected from an outer circumference of the inner cylinder 972 and a small generator member 20 is attached to the outer cylinder 981 and situated in a space 982 formed between the inner cylinder 972 and the outer cylinder 981. When the door is locked, the housing 23 faces the magnet 61 through the elastic member 42 made of a leaf spring. As the inner cylinder 972 is turned to unlock the door, the elastic member 42 starts to be deformed, with the generator member 20 remaining attracted to the control member 60. When the magnet 61 parts from the generator member 20, the generator member 20 oscillates by the snapping action of the elastic member 42. As a result, the generator member 20 self-generates electricity, causing the transmission unit 32 (not shown in FIG. 11) to issue a first alarm signal. In this configuration, this security device 2 may be formed as a product already incorporated into the lock 7.

As shown in the Embodiment 3, the security device 2 can be mounted not only to the door 91 but also to any desired portion that is displaced as the door 91 is opened. By reducing the size of the security device 2, it can be formed as a product already built into the door 91 as well as into any member associated with the door. Other operations and advantages of this example are similar to those of the Embodiment 1.

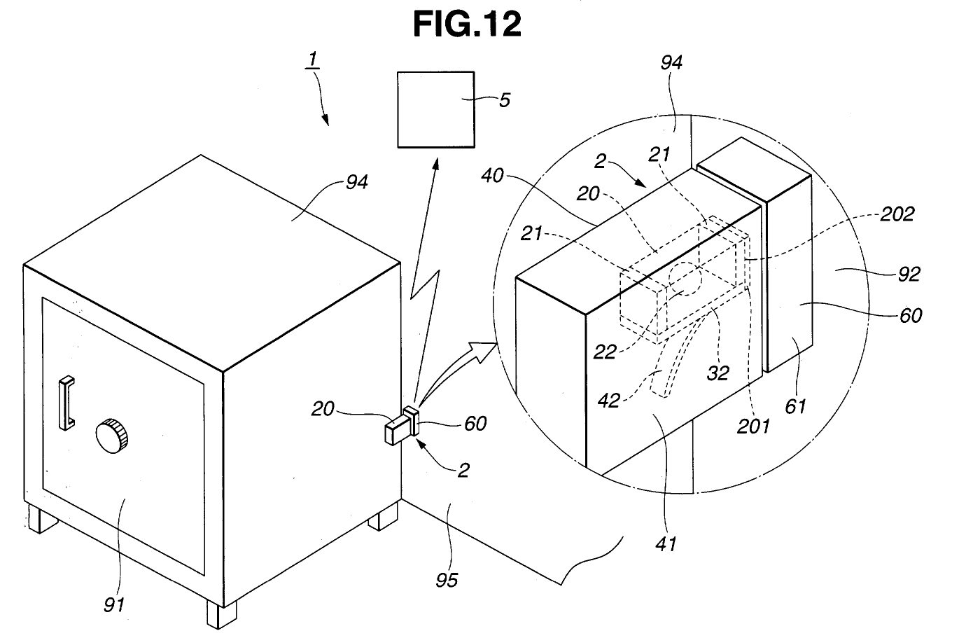

Next, a security device of Embodiment 4 according to the present invention will be described by referring to the drawings. FIG. 12 is an explanatory view of a security device of the Embodiment 4. Parts that are identical with those of the Embodiment 1 are given like reference numbers and their explanations are omitted.

The security device 2 of the Embodiment 4 is characterized in that one of the generator member 20 and the control member 60 is mounted to an object 94 that has a possibility of being moved and the other to a nearby object 95 that parts from the object 94 as the latter is moved. Other structural aspects are similar to those of the Embodiment 1 shown in FIG. 2 to FIG. 6 or to those of the Embodiment 2.

The object 94 is an object that may be moved and taken away by a burglar. While FIG. 12 shows it to be a safe, it may be CDs, ATMs, jewel boxes, paintings, and fixtures. The nearby member 92 in this case may be a floor, wall, adjoining furniture and other objects. In the Embodiment 4 of the above construction, when a burglar moves the object 94 in an attempt to steal it, the generator member 20 parts from the magnet 61 of the control member 60, resulting in the same operation as described in the Embodiment 1 whereby the generator member 20 continually self-generates electricity to cause the transmission unit 32 to set off a first alarm which in turn causes the detection device 5 to execute a second alarm.

As shown in the Embodiment 4, the security device 2 can be installed not only on the door 91 but also on any object 94 that has a possibility of being stolen. Because of the absence of power supply wires, the security device is not easily noticed and there is no fear that an alarm system may be shut down by a burglar cutting off a power supply wire in an attempt to steal a safe or other objects. Further, if a burglar should notice the security device 2 and separate the generator member 20 and the control member 60 from each other, this very act alone causes the generator member 20 to self-generate electricity. Other operations and advantages are similar to those of the Embodiment 1. It is of course possible to combine this arrangement with the Embodiment 1 to provide the security device 2 also to the door of the safe for a double security.

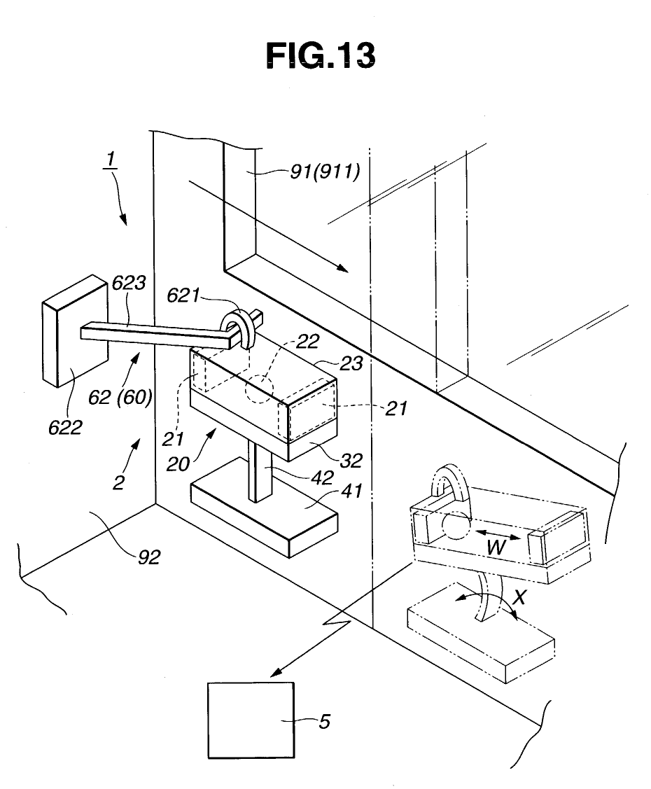

Next, a security device of Embodiment 5 according to the present invention will be described by referring to the drawings. FIG. 13 shows a concept of a security system according to the Embodiment 5. Parts identical with those of the Embodiment 1 are given like reference numbers and their detailed descriptions are omitted.

Unlike the Embodiment 1 to Embodiment 4 that use a magnetic force acting between the generator member 20 and the control member 60, the security device 2 of the Embodiment 5 is characterized in that the generator member 20 and the control member 60 are engaged with each other. An engagement means 62 is provided as the control member 60. When the generator member 20 and engagement means 62 move away from each other, the generator member 20 that is kept from undergoing oscillation by the engagement means 62 disengages from the engagement means 62 to become free to oscillate. Other structural aspects are similar to those of the Embodiment 1 shown in FIG. 3 to FIG. 6.

FIG. 13 shows that the generator member 20 is attached to a lower end portion on the indoor side of a sliding window 911, which function as a moving part or door 91, and that the engagement means 62 as the control member 60 is attached to a part of the window frame on the indoor side, which function as a nearby member 92. The housing 23 has on its upper surface an engagement receiving portion 621 with a through-hole, and an elastic or resilient engagement piece 623 as the engagement means 62 protrudes like a cantilever beam from a base portion 622 secured to the nearby member 92 and is bent at the front end. With the front end of the engagement piece 623 engaged in the engagement receiving portion 621, the generator member 20 is held immovable to prevent the self-generation. Unlike the Embodiment 1, the generator member 20 does not have a case 40. The elastic member 42 is attached to the generator member 20 so that an X direction in which it is most easily displaced coincides with the direction in which the moving window or door 91 is opened.

In the Embodiment 5 constructed as described above, when the window 91 is closed, the front end of the engagement piece 623 is engaged in the engagement receiving portion 621, as shown in FIG. 13, keeping the generator member 20 from undergoing the oscillation action. While FIG. 13 shows the elastic member 42 connecting the generator member 20 and the base portion 41 to be upright, the elastic member 42 may assume a tilted position. As the window 91 is opened, the generator member 20 is gradually moved away and tilted progressively deeper by the restrictive action of the engagement means 62 until the front end of the engagement piece 623 disengages from the engagement receiving portion 621 by its elasticity. As a result, the generator member 20 starts oscillating and, by the elastic member 42, continues its oscillation to continually self-generate electricity. Using this generated power the transmission unit 32 issues a first alarm signal which in turn causes the detection device 5 to execute a second alarm.

As shown in the Embodiment 5, the control member 60 that either enables the generator member 20 to generate electricity or disables it may use the engagement means 62 as well as a magnetic force and thus can suitably be applied to locations where the magnetic force is difficult to use. The arrangement and structure of the engagement means 62 are not limited to those shown in FIG. 13. Other operations and advantages are similar to those of the Embodiment 1.

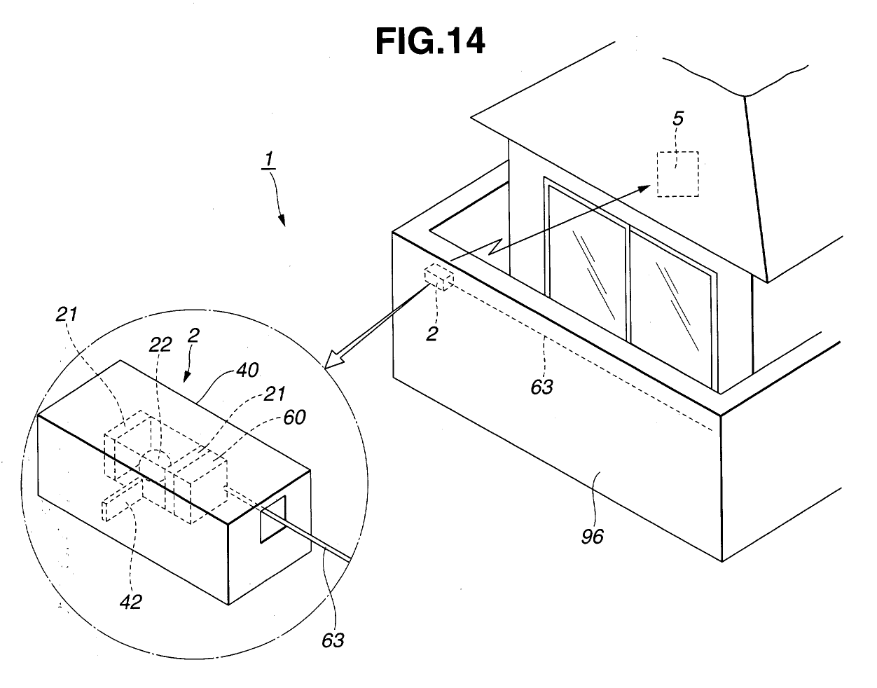

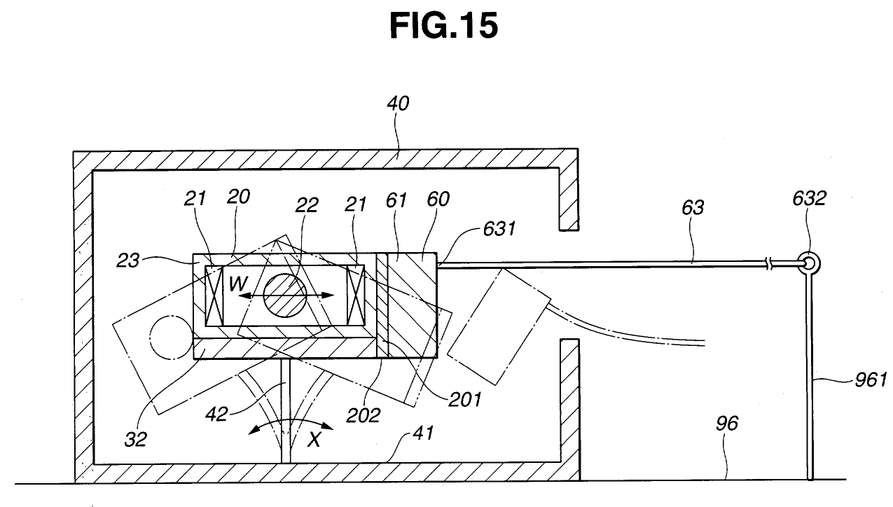

Next, a security device of Embodiment 6 according to the present invention will be described by referring to the drawings. FIG. 14 is an explanatory view of the security device of the Embodiment 6 and FIG. 15 is a cross-sectional view of the security device of the Embodiment 6 as seen from above. Parts identical with those of the Embodiment 1 are given like reference numbers and their detailed descriptions are omitted.

The security device 2 of the Embodiment 6 has a generator member 20, which comprises piezoelectric elements 21 and a impact member 22 and in which the impact member 22 impinges on the piezoelectric elements 21 to generate electricity; an alarm unit (transmission unit 32) which is energized by the power thus generated to issue an alarm; and a line member 63 laid near a fence or wall and connected directly or indirectly to the generator member 20. The generator member 20 is displaced by a change in a tension of the line member 63 to generate electricity.

In FIG. 14, the security device 2 is installed on the inner side of the fence 96 surrounding the house, with the line member 63 stretched along the fence 96. The line member 63 does not have to be stretched along the fence 96 as long as it is so arranged as to come into contact with a burglar and thereby detect a tension change as the burglar climbs over the fence. It may be laid on the outer side of the fence as needed. In addition to the fence 96, it may also be stretched along a wall and a hedge or along the ground.

In this embodiment, the control member 60 includes the magnet 61 and the line member 63. The case 40 accommodates the generator member 20 and the magnet 61 and mounted to the fence 96 by an appropriate means (bonding agent, double-sided adhesive tape, screws, etc.). The generator member 20 is connected through the elastic member 42 to the side surface of the case 40 which also serves as the base portion 41. The elastic member 42 is attached to the generator member 20 in such a manner that the X direction in which it is most easily displaced agrees with a direction in which it is pulled by the line member 63. The control member 60 has a magnet 61 to which one end 631 of the line member 63 is connected, the other end 632 being connected to a support member 961 secured to the fence 96. The line member 63 as a whole is stretched with a tension. A magnetic layer 201 in the form of a magnetic metal plate is bonded to a side surface 202 of the generator member 20 on the control member 60 side. Normally the magnet 61 and the generator member 20 are attracted to each other. The line member 63 may suitably use a fine wire or piano wire. The elastic member 42 has a spring constant such that it is not deformed when the line member 63 is disturbed by wind. Other aspects of the construction are similar to those of the Embodiment 1 shown in FIG. 3 to FIG. 6.

In the Embodiment 6 constructed as described above, normally the line member 63 is stretched along the fence 96, with the magnet 61 at one end 631 thereof magnetically attracted to the generator member 20. That is, the line member 63 is indirectly connected to the generator member 20. When a burglar climbs over the fence 96 and contacts the line member 63, the line member 63 is pulled moving the magnet 61 in a direction away from the generator member 20. The generator member 20 magnetically attracted to the magnet 61 is also pulled and inclines until the magnet 61 completely parts from the generator member 20, at which time the generator member 20 snaps back to oscillate and continues its oscillating action by the elasticity of the elastic member 42 to generate electricity as in the Embodiment 1. The power thus generated causes the transmission unit 32 to issue a first alarm signal, which in turn causes the detection device 5 to execute a second alarm.

The use of the line member 63 as shown in the Embodiment 6 enables the security device and the security system of this invention to be applied also to fences and walls. Other operations and advantages are similar to those of the Embodiment 1. If the piezoelectric elements 21 of the generator member 20 have a high generation efficiency and can produce enough electricity for transmission without the repetitive impinging action of the impact member 22, the magnet 61 may be omitted and the line member 63 of the control member 60 may be connected directly to the generator member 20.

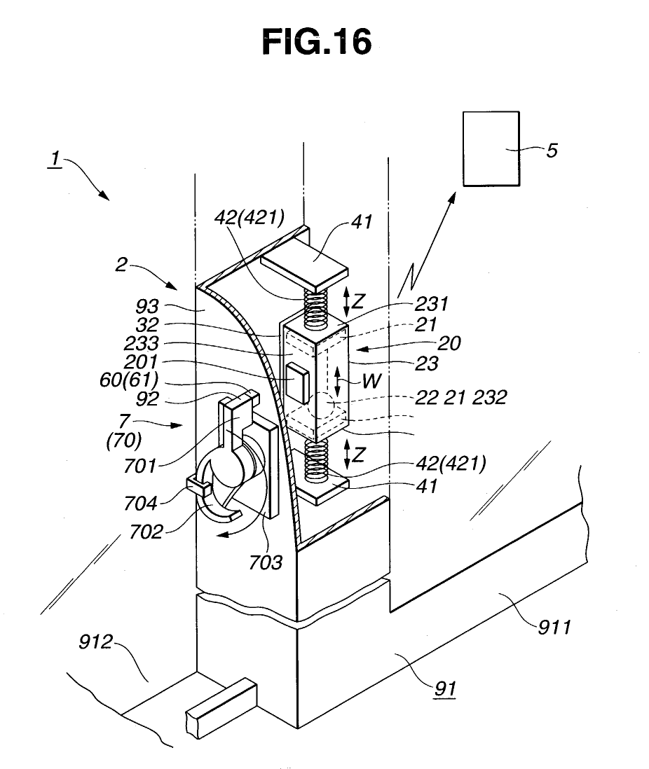

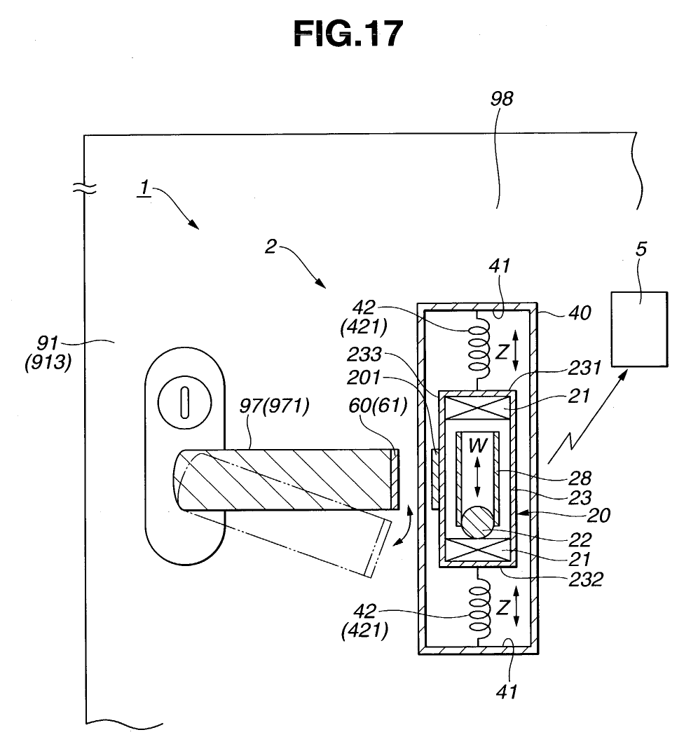

Next, a security device of Embodiment 7 according to the present invention will be described by referring to the drawings. FIG. 16 is an explanatory view of the security device of the Embodiment 7 and FIG. 17 illustrates how the Embodiment 7 can be applied. Parts identical with those of the Embodiment 1 are given like reference numerals and their detailed explanations are omitted.

The security device 2 of the Embodiment 7 is an applied example of the security device 2 of the Embodiment 1 and is characterized in that elastic members 42 made of an elastic material are provided at both ends of the housing 23 so that the impact member 22 is oscillated by the elongation and contraction of the elastic members 42 to strike against the piezoelectric elements 21 repetitively.

FIG. 16 shows the security device 2 installed near a lock 7 of a window 91, with the generator member 20 mounted in the window 91 and the control member 60 attached to a nearby member 92. Chosen as the nearby member 92 is a part of the lock 7 that parts from the window 91 as it is opened. The window 91 consists of sliding glazed windows 911, 912 which are formed of a material permeable to a magnetic force, such as aluminum sash. The generator member 20 is installed in a space inside the sash portion to face the lock 7. Other structural aspects are similar to those of the Embodiment 1 shown in FIG. 3 to FIG. 6.

In the generator member 20, the elastic members 42 are connected at one end to opposite end faces 231, 232 of the housing 23 so that a direction (Z direction) in which the elastic members 42 expand or contract coincides with a direction (W direction) in which the impact member 22 strikes against the piezoelectric elements 21. While the Embodiment 1 makes use of the bending of the elastic member 42, the Embodiment 7 utilizes the contraction and expansion of the elastic members 42. So the elastic members 42 are denoted here as expansible elastic members 421. The expansible elastic members 421 are connected at the other end to base portions 41 protruding into the inner space inside the sash portion. That is, the housing 23 is held between the opposing base portions 41 with the expansible elastic members 421 interposed therebetween. When the lock 7 is engaged, the housing 23 rests at a neutral position. A magnet as the magnetic layer 201 is provided on a side surface 233 of the housing 23 facing the lock 7. On another side surface of the housing 23 the transmission unit 32 is mounted.

A crescent lock 70 is used as the lock 7. The crescent lock 70 includes a base plate portion 703 mounted to one side 93 of one sliding window 911; a handle portion 701 rotatably mounted on the base plate portion 703 and gripped and rotated by hand when engaging or disengaging the lock; an engagement portion 702 formed integral with the handle portion 701 and slid into a receiving portion 704 described later when engaging the lock; and the receiving portion 704 mounted on one side 93 of the other sliding window 912. The magnet 61 of the control member 60 is attached to the front end of the handle portion 701 so that it faces the generator member 20. When the handle portion 701 is in the locked position, this magnet 61 faces and attracts the magnetic layer 201 of the generator member 20 through the sash portion of the window 91.

In this construction, when, in the process of opening the window 91, the handle portion 701 is turned downward to disengage the engagement portion 702 of the crescent lock 70 from the receiving portion 704, the magnet 61 attached to the front end of the handle portion 701 is also rotated downward. A change in the magnetic force causes the magnetic layer 201 of the generator member 20 to be pulled down until the expansible elastic members 421 reach their limit of elasticity, at which time the generator member 20 parts from the magnet 61 and snaps back, entering into an oscillating action with the expansible elastic members 421 expanding and contracting in the Z direction. As a result, the generator member 20 self-generates electricity, causing the transmission unit 32 to issue a first alarm signal.

In the Embodiment 7, during the oscillation state the generator member 20 simply moves vertically between the opposing base portions 41, 41, so that, when compared with FIG. 8 of the Embodiment 1, the space required for the vibratory displacement can be made smaller. This allows the generator member 20 to be installed in a narrow internal space, which in turn offers an advantage of being able to conceal the generator member 20 with ease. Other operations and advantages are similar to those of the Embodiment 1.

FIG. 17 shows an applied example of the security device 2 of the Embodiment 7. FIG. 17 shows the security device 2 mounted on a front door 913 (door 91). In the figure, the moving portion 97 is chosen to be a door handle 971 on the inner side of the door 913, with the magnet 61 of the control member 60 attached to an end of the door handle 971. While FIG. 17 shows an L-shaped door handle 971, any type of handle, such as a round knob, may be used. The generator member 20 is accommodated in a boxlike case 40 having the base portions 41, 41 as part its sides. It is possible to omit the case 40 and have the base portions 41 protrude from the door 91. In this construction, with the door 913 closed, the magnetic layer 201 of the generator member 20 faces, and is attracted by, the magnet 61 through the case 40. When the door handle 971 is pushed down to open the door 913, the magnet 61 is also moved down, pulling the generator member 20 by magnetic attraction. When the generator member 20 moves down to the limit of elasticity of the expansible elastic members 421, it parts from the magnet 61 and snaps back into the oscillation state. The generator member 20 thus self-generates electricity, causing the transmission unit 32 to issue a first alarm signal.

In implementing the foregoing Embodiment 1 to Embodiment 7, they may be combined in a desired manner. The security system 1 may be constructed of a plurality of security devices 2 of the Embodiment 1 to 7 and may detect signals from these security devices by one detection device.

In the security device and security system of the present invention as detailed above, since the security device self-generates electricity, it requires no power supply wires and thus can be installed at any location where the burglary prevention measure is necessary, such as locations where wiring in the conventional device would show up or where a power supply circuit cannot be wired easily. This eliminates a fear that a burglar may notice the wiring and therefore the security device and cut a power supply wire. As a result, the reliability of the security device is enhanced.

Further, since the security device self-generates electricity at time of a break-in and does not consume a power during standby, there is no operational cost for keeping the security device energized. This allows the device to be installed wherever needed without worrying about the operational cost. This in turn enhances the level of security.

Since the security device has a simple construction, the parts cost can be reduced. Further, since the device can be formed in a reduced size, it can be installed inside a door or window, hidden from external view. This makes the device hard to notice.

What is claimed is:

1. A security device comprising:
a generator member having a piezoelectric element and an impact member, the impact member striking against the piezoelectric element to generate electricity;
wherein a status change is detected at a location that requires an antiburglary protection, and a power produced by the generator member is used to raise an alarm.

2. A security device comprising:
a generator member having a piezoelectric element and an impact member, the impact member striking against the piezoelectric element to generate electricity;
an alarm unit to issue an alarm by using the generated power; and
a control member to control an operation of the alarm unit;
wherein one of the generator member and the control member is mounted on a door or window and the other is mounted on a nearby portion that parts from the door or window as the door is opened;
wherein when the door or window is opened, the control member causes the alarm unit to operate.

3. A security device comprising:
a generator member having a piezoelectric element and an impact member, the impact member striking against the piezoelectric element to generate electricity;
an alarm unit to issue an alarm by using the generated power; and
a control member to control an operation of the alarm unit;
wherein one of the generator member and the control member is mounted on a displacement portion that is displaced when a door or window is opened and the other is mounted on a nearby portion that parts from the displacement portion when the door or window is opened;
wherein when the door or window is opened, the control member causes the alarm unit to operate.

4. A security device comprising:
a generator member having a piezoelectric element and an impact member, the impact member striking against the piezoelectric element to generate electricity;
an alarm unit to issue an alarm by using the generated power; and
a control member to control an operation of the alarm unit;
wherein one of the generator member and the control member is mounted on an object that has a possibility of being moved and the other is mounted on a nearby portion that parts from the object when the object is moved;
wherein when the object is moved, the control member causes the alarm unit to operate.

5. A security device comprising:
a generator member having a piezoelectric element and an impact member, the impact member striking against the piezoelectric element to generate electricity;
an alarm unit to issue an alarm by using the generated power; and
a line member provided near a fence or wall and directly or indirectly connected to the generator member;
wherein the generator member is displaced by a change in a tension of the line member to generate electricity.

6. A security device according to any one of claim 1 to 5, wherein the generator member has a housing accommodating the piezoelectric element and the impact member and an elastic member having an elasticity and attached to the housing to oscillate the housing so that the impact member repetitively strikes against the piezoelectric element.

7. A security device according to claim 6, wherein the elastic member is formed from an elastic body having a directivity in a spring constant and is connected to the housing such that a direction of the smallest spring constant of the elastic member agrees with a direction in which the impact member impacts the piezoelectric element.

8. A security device according to claim 6, wherein the elastic member is formed from an elastic body having an expansibility, the elastic member is provided at both ends of the housing, and a contraction and expansion of the elastic members causes the impact member to oscillate and repeat impacting the piezoelectric element.

9. A security device according to claim 8, wherein the elastic member is attached to both opposite ends of the housing such that a direction of the contraction and expansion of the elastic member agrees with a direction in which the impact member impacts the piezoelectric element.

10. A security device according to any one of claim 2 to 9, wherein a magnetic force is generated between the generator member and the control member, and when a change occurs in the magnetic force as a result of a parting between the control member and the generator member, the control member causes the generator member to start oscillating to operate the alarm unit.

11. A security device according to any one of claim 2 to 9, wherein the generator member and the control member engage each other, and when they disengage from each other as a result of a parting between the control member and the generator member, the control member causes the generator member to start oscillating to operate the alarm unit.

12. A security device according to any one of claim 2 to 9, wherein a magnetic force is generated between impact member and the control member, and when a change occurs in the magnetic force as a result of a parting between the control member and the impact member, the control member causes the impact member to impact the piezoelectric element to operate the alarm unit.

13. A security system comprising:
a security device as claimed in any one of claim 1 to 12; and
a detection device installed apart from the security device;
wherein the security device issues a first alarm by transmitting a signal to the detection device and the detection device receives the signal to issue a second alarm.

14. A security system according to claim 13, wherein the detection device issues the second alarm by communicating a notification to an outside world through a network.

15. A security system according to claim 13 or 14, wherein the detection device is controlled from outside to enable or disable the issuing of the second alarm.
